(19) United States
(12) Patent Application Publication
(10) Pub. No.: US 2004/0177113 A1
(43) Pub. Date: Sep. 9, 2004

(54) Method, system, and article of manufacture for display of hierarchical data

(75) Inventor: Shawn X. Nguyen, Golden, CO (US)

Correspondence Address: CHAPIN & HUANG L.L.C., WESTBOROUGH OFFICE PARK, 1700 WEST PARK DRIVE, SUITE 120, WESTBOROUGH, MA, 01581, US

(73) Assignee: Sun Microsystems, Inc.

(21) Appl. No.: 10/383,907

(22) Filed: Mar. 7, 2003

(51) Int. Cl. G06F 15/16

(52) U.S. Cl. 709/203

(57) ABSTRACT

Provided are a method, system and article of manufacture. A request is received for performing an operation. The requested operation is performed on a hierarchically arranged data. Code is generated corresponding to a display of the hierarchically arranged data in a single window. The generated code is sent.

### BACKGROUND OF THE INVENTION

1. Field of the Invention

The present invention relates to a method, system, and an article of manufacture for display of hierarchical data.

2. Description of the Related Art

A user interface may display hierarchically arranged data, such as, directories and files in a file system, in many different views. For example, the directories, subdirectories and files in a file system may be displayed in a tree view in some operating systems. The directories, subdirectories and files are nodes of the tree view. A user may navigate the folders, subfolders and files by selecting appropriate nodes of the tree view.

A user may create a new file or a new directory and the newly created file or directory may appear as nodes in the tree view. Similarly if the user deletes a file or a directory then the deleted file or directory would disappear from the tree view. Other operations may also be performed on the hierarchically arranged data and the results of the operation would be reflected in the displayed nodes of the tree view.

Web browsers may display hierarchically arranged data via frames. For example, a Web browser may display a tree view corresponding to a file system in a first frame, and the data corresponding to a node of the tree view may be displayed in a second frame. The two frames are two different windows on the Web browser and the two frames appear simultaneously on the Web browser. A user may select a node of the tree view on the first frame and the data corresponding to the selected node may be displayed on the second frame.

### SUMMARY

Provided are a method, system and article of manufacture. A request is received for performing an operation. The requested operation is performed on a hierarchically arranged data. Code is generated corresponding to a display of the hierarchically arranged data in a single window. The generated code is sent.

In additional implementations, the generation further comprises creating a first code corresponding to a tree display of the hierarchically arranged data, creating a second code corresponding to a content of a node of the hierarchically arranged data, and creating a third code corresponding to at least one control for manipulating the hierarchically arranged data.

In further implementations, the receiving, performing, generating and sending are performed by a server side application. If the requested operation is for opening or closing a node in the display of the hierarchically arranged data, then corresponding information is retrieved from a cache coupled to the server side application, wherein the cache stores an arrangement of a plurality of nodes including the node in the display of the hierarchically arranged data.

Provide are an additional method, system and article of manufacture. A first page is displayed in one window, wherein the first page includes a first hierarchical arrangement of nodes, at least one control related to the nodes, and a content of a node. At least one control is selected to perform an operation remotely on at least one node.

The implementations create a navigation tree in a Web page. Associated with the navigation tree are controls for adding, deleting, and editing nodes of the navigation tree. The content of a node of the navigation tree may be displayed on the Web page. The navigation tree, the controls, and the content are all displayed in a single window without frames.

### BRIEF DESCRIPTION OF THE DRAWINGS

Referring now to the drawings in which like reference numbers represent corresponding parts throughout:

FIG. 1 illustrates a block diagram of a computing environment, in accordance with certain described aspects of the invention;

FIG. 2 illustrates a block diagram of a browser with a single window, in accordance with certain described implementations of the invention;

FIG. 3 illustrates a block diagram of an exemplary tree data, in accordance with certain described implementations of the invention;

FIG. 4 illustrates a block diagram of a browser including an exemplary tree display, in accordance with certain described implementations of the invention;

FIG. 5 illustrates a block diagram of an exemplary single line tree display data structure, in accordance with certain described implementations of the invention;

FIG. 6 illustrates an exemplary tree display region constructed from the exemplary single line tree display data structure, in accordance with certain described implementations of the invention;

FIG. 7 illustrates a session cache implemented in a server, in accordance with certain described implementations of the invention;

FIG. 8 illustrates logic for generating a Web page in a server side application, in accordance with certain described implementations of the invention;

FIG. 9 illustrates logic for using a session cache for generating a Web page in a server side application, in accordance with certain described implementations of the invention; and

FIG. 10 illustrates a block diagram of a computer architecture in which certain described aspects of the invention are implemented.

### DETAILED DESCRIPTION

In the following description, reference is made to the accompanying drawings which form a part hereof and which illustrate several implementations. It is understood that other implementations may be utilized and structural and operational changes may be made without departing from the scope of the present implementations.

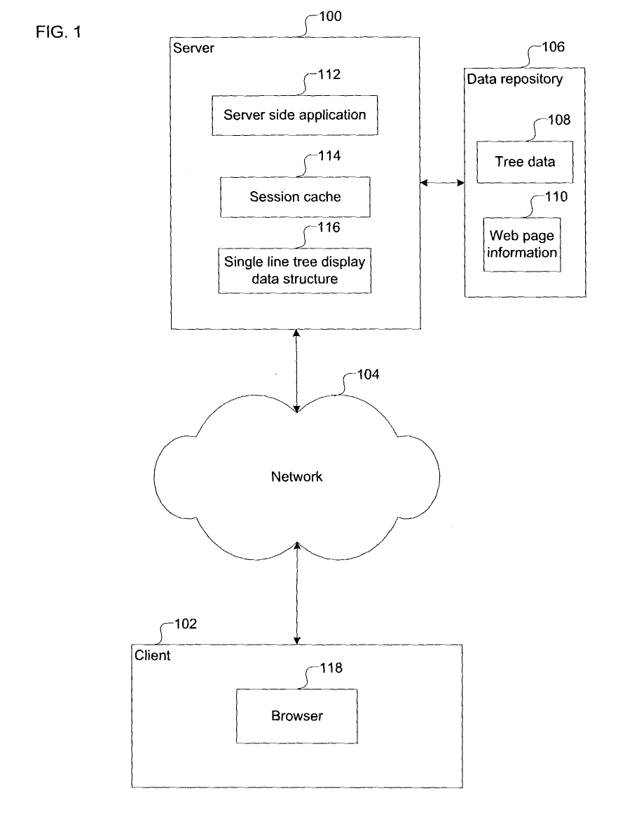

FIG. 1 illustrates a block diagram of a computing environment, in accordance with certain aspects of the invention. A server 100 and a client 102 are coupled over a network 104. The server 100 and the client 102 may comprise any computational device known in the art, such as a personal computer, a workstation, a server, a mainframe, a hand held computer, a palm top computer, a telephony device, a network appliance, etc. The network 104 may be any network known in the art, such as the Internet, an intranet, a Local area network (LAN), a Storage area network (SAN), a Wide area network (WAN), a wireless network, etc. The network may be part of one or more larger networks or may be an independent network or may be comprised of multiple interconnected networks. The server 100 may alternatively be connected to the client 102 without a network, such as through direct lines, common bus systems, etc., in a manner known in the art.

The server 100 is coupled to a data repository 106. The data repository 106 may be any data repository known in the art and may include a database management system implemented in a computational device, a file system stored in a storage device, etc. The data repository 106 may include tree data 108, where the tree data 108 includes data that is arranged hierarchically as a tree. The nodes of the tree represent data and the parent-child relationships within the tree reflect the relationships among the data. For example, the tree data 108 may reflect the hierarchical arrangement of directories, subdirectories and files in a file system. In certain implementations, a node of the tree data 108 maybe a directory or a file, with the leaf nodes indicating files. In certain alternative implementations the internal representation of the tree data 108 in the data repository 108 may be in a format that is non-hierarchical. The data repository 106 may also include Web page information 110, where the Web page information 110 is a collection of Web pages.

The server 100 comprises a server side application 112, a session cache 114, and a single line tree display data structure 116. The server side application 112 interacts with a browser 118 included in the client 102. The server side application 112 responds to requests from the browser 118 by extracting data from the session cache 114, the tree data 108 and the Web page information 110 and reformatting portions of the extracted data via the single line tree display data structure 116. Subsequently the server side application 112 sends a page including the reformatted portions to the browser 118. The browser 118 receives the page sent by the server side application 112 and displays the page in a window that includes at most one frame. The displayed page includes a tree, content of at least one node of the tree and controls to manipulate the tree.

Therefore, in the system described in FIG. 1 a server side application 112 interacts with a browser 118 to send the browser 118 a page that includes a tree, content of at least one node of the tree and controls to manipulate the tree.

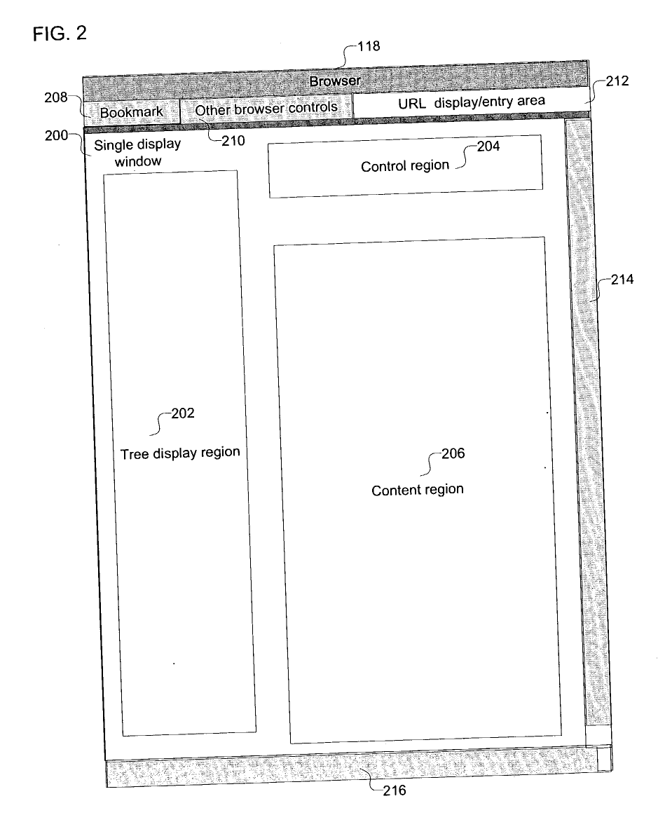

FIG. 2 illustrates a block diagram of the browser 118, in accordance with certain implementations of the invention. The browser 118 includes a single display window 200 that does not include any frames. In certain alternative implementations, the single display window 200 may include at most one frame, i.e., the single display window does not include multiple frames.

The single display window 200 includes a tree display region 202, a control region 204 and a content region 206. The tree display region 202 includes the display of hierarchical data represented as a tree. The nodes of the tree reflect data elements and the parent-child relationship of the nodes within the tree reflect an arrangement of the data elements. The content region 206 displays the data contained in any of the nodes of the tree displayed in the tree display region 202. The control region 204 includes controls for manipulating the nodes that may be associated with the tree displayed in the tree display region 202.

The browser 118 includes a bookmark control 208, other browser controls 210, a Universal resource locator (URL) entry/display area 212, and may include one vertical scrollbar 214 and one horizontal scroll bar 216. The bookmark 208 control is for bookmarking a page displayed in the frameless window 200. The other browser controls 210 may include controls for filing, printing and viewing Web pages. The URL display/entry area 212 shows the URL associated with a page displayed in the single display window 200. A user may bookmark the URL displayed in the URL display/entry area 212 by selecting the bookmark control 208.

Therefore, FIG. 2 shows a browser 118 that has a single display window 200. The browser 118 displays a tree, controls associated with the nodes of the tree, and content associated with the nodes of the tree in the single display window 200.

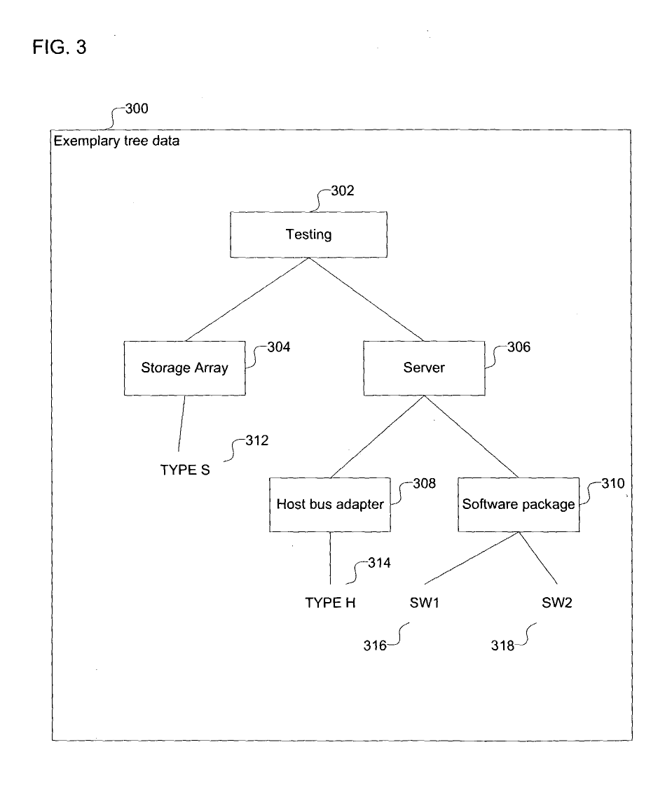

FIG. 3 illustrates a block diagram of an exemplary tree data 300, in accordance with certain implementations of the invention. The exemplary tree data 300 is a representative example of the tree data 108 stored in the data repository 106.

The exemplary tree data 300 is arranged as a tree, where the nodes of the tree may be directories or files. In the exemplary tree data 300, the nodes for directories include testing 302, storage array 304, server 306, host bus adapter 308, and software package 310. The nodes for files include TYPE S 312, TYPE H 314, SW1 316 and SW2 318. For example, the node testing 302 may have the node storage array 304 and the node server 306 as children, where the child nodes are subdirectories of the testing 302 directory. The node software package 310 has the nodes SW1 316 and SW2 318 as children, where the child nodes are files in the software package 310 directory. The files may contain any type of data known in the art, and may comprise Hypertext markup language (HTML) files, image files, plain text files, etc.

In alternative implementations, the exemplary tree data 300 may be arranged in a manner different from a tree. For example, in certain implementations the exemplary tree data 318 may be substituted by a graph.

Therefore, FIG. 3 displays the exemplary tree data 300 as a collection of directories, subdirectories and files arranged in the form of a tree.

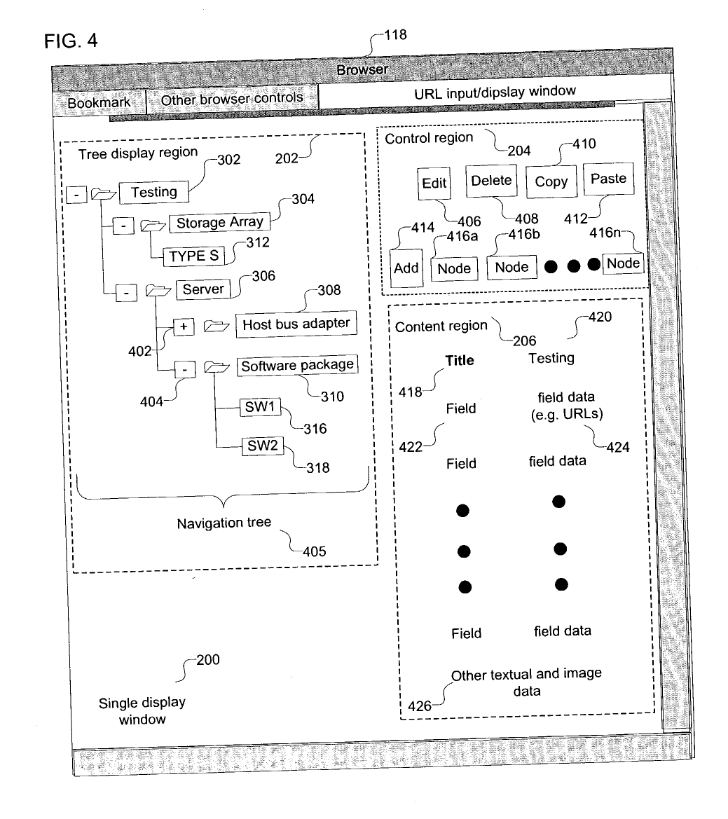

FIG. 4 illustrates a block diagram of the browser 118 including a display of the exemplary tree data 300, in accordance with certain implementations of the invention.

The tree display region 202 shows a display of the exemplary tree data 300. Each non-leaf node displayed in the tree display region 202 can be expanded or contracted by clicking on an open/close icon, such as, the open/close icon 402 associated with the host bus adapter 308 node. Since the open/close icon 402 indicates a “+”, clicking on the open/close icon 402 would send a request from the browser 118 to the server side application 112, where the request is to display the children of the host bus adapter 308 node. A new page received from the server side application 112 by the browser 118 would be interpreted by the browser 118. The browser 118 would then display the tree corresponding to the exemplary tree data 300, where the tree includes the child type H 314 of the host bus adapter 308 node and the open/close icon 402 would indicate a “−”. Similarly, selecting the open/close icon 404 associated with the software package 310 node would send a request to the server side application 112 to return a page that includes code to remove the nodes SW1 312 and SW2 318 from the tree display region 202. Selecting a node, such as, SW 1 316, in the tree display region 202 may display the content of the node in the content region 206. Since the tree displayed in the tree display region 202 can be navigated by opening and closing nodes or by selecting nodes, the tree is a navigation tree 405.

The control region 204 displays at least one control for manipulating nodes related to the exemplary tree data 300. For example, selecting an edit 406 control may allow the contents of a node displayed in the content region 306 to be edited. Selecting a delete 408 control allows the deletion of a node. Selecting a copy 410 control allows the copying of a node and selecting a paste 412 control allows the pasting of a node that may have been copied or deleted earlier. Selecting an add 414 control may allow one or more of nodes 416a, 416b, . . . 416n to be added to the exemplary tree data 300 and a corresponding tree display may be displayed in the tree display region 202.

The content region 206 displays the data contained in any of the nodes of the navigation tree 405 displayed in the tree display region 202. For example, the title 418 field may indicate testing 420, thereby implying that the testing 302 node is being displayed in the content region 206. There may be alternative ways of displaying nodes in the content region 206. The content region 206 may display the content of both leaf and non-leaf nodes of the exemplary tree data 300, and the displayed content may include fields, such as field 422, and corresponding field data 424 including URLs. The content region 206 may also include other textual and image data 426 corresponding to a node of the exemplary tree data 300. The data displayed in the content region may be determined by the selection of a node, such as, node SW2 318, in the navigation tree 405.

Therefore, FIG. 4 shows a browser 118 displaying the navigation tree 405, controls associated with the nodes of the navigation tree 405, and content associated with the nodes of the navigation tree 405. The navigation tree 405 is displayed in the single display window 200.

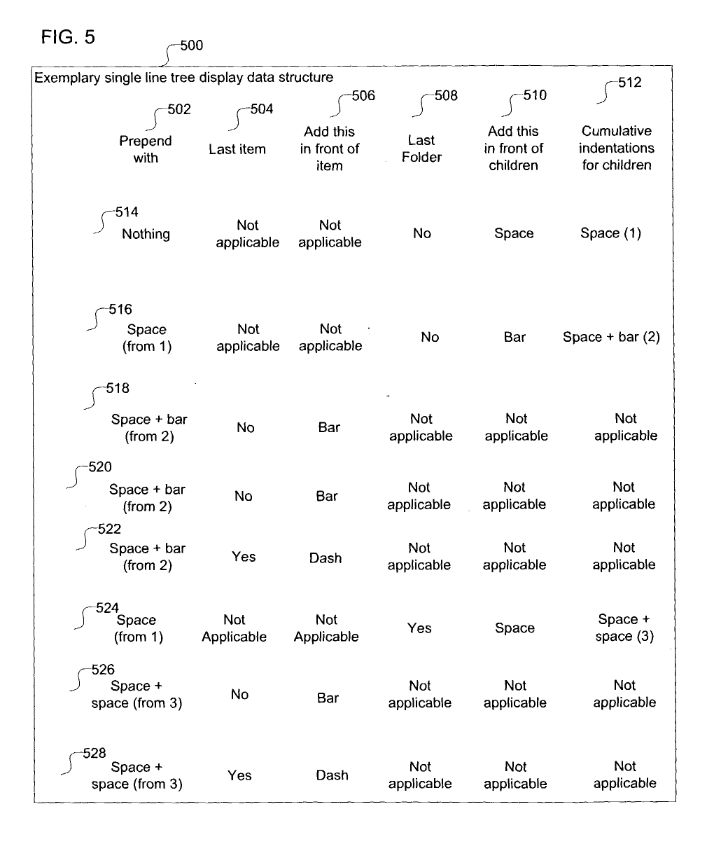

FIG. 5 illustrates a block diagram of an exemplary single line tree display data structure 500, in accordance with certain implementations of the invention. The exemplary single line tree display data structure 500 is an example of the single line tree display data structure 116 included in the server 100.

The exemplary single line tree display data structure 500 stores a representation of the navigation tree 405 that is displayed in the tree display region 202 of the browser 118. The representation is in a form such that the server side application 112 can interpret the exemplary single line tree display data structure 500 to generate textual code that is sent to the browser. The textual code does not include HTML tables and can be interpreted by the browser 118 to display the navigation tree 405 in the tree display region 202. Since the textual code does not include tables the browser 118 can display the navigation tree 405 even if the browser 118 does not support tables (such as, a text only browser). Table interpretation via a browser also takes greater processing time than the interpretation of non-tabular textual code.

The exemplary single line tree display data structure 500 includes fields “prepend with” 502, “last item” 504, “add this in front of item” 506, “last folder” 508, “add this in front of children” 510, “cumulative indentations for children” 512, where the fields 502, 504, 506, 508, 510, 512 are present for each row 514, 516, 518, 520, 522, 524, 526, 528. While only eight rows 514, 516, 518, 520, 522, 524, 526, 528 that may correspond to a navigation tree with eight nodes are shown, there may be fewer or more rows in the exemplary single line tree display data structure 500.

The entries for each row 514, 516, 518, 520, 522, 524, 526, 528 are interpreted by the server side application 1 12 to generate code for displaying a corresponding node in the tree display region 202. The “prepend with” 502 field indicates the formatting the node should be prepended with. The “last item” 504 field indicates whether the node is a last child when the parent of the node has one or more children. The “add this in front of item” field 506 indicates the formatting to be added in front of the displayed node in the corresponding navigation tree. The “last folder” 504 field indicates whether the node is a last folder when the parent node includes one or more folders as children. The “add this in front of children” 510 field indicates the formatting to be added before each child of the node in the corresponding navigation tree. The “cumulative indentation for children” 512 field indicates the total indentation for children of the node in the corresponding navigation tree.

For example, the entries for row 514 indicate that when the first node of the corresponding navigation tree is displayed in the tree display region 202 of the browser 118, the name of the first node should not be prepended with anything as the “prepend with” 502 field is nothing.

Therefore, FIG. 5 shows an exemplary single line tree display data structure 500 that is interpreted by the server side application 112 to generate the code for displaying a corresponding navigation tree, where the code is non-tabular textual HTML code.

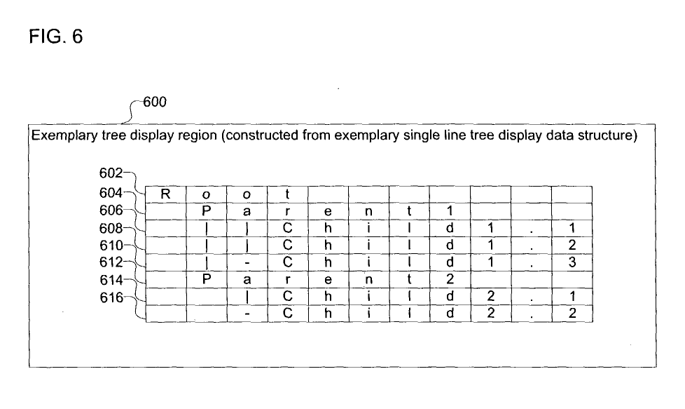

FIG. 6 illustrates an exemplary tree display region 600 constructed from the exemplary single line tree display data structure 500, in accordance with certain implementations of the invention. The exemplary tree display region 600 may be displayed in the browser 118.

The nodes of the navigation tree corresponding to the exemplary tree display region 600 are “Root” 602, “Parent1” 604, “Child1.1” 606, “Child1.2” 608, “Child1.3” 610, “Parent2” 612, “Child2.1” 614, “Child2.2” 616. For example, the formatting of the node “Root” 602 corresponds to the interpretation by the server side application 112 of row 514. The formatting of the node “Parent1” 604 corresponds to the interpretation by the server side application 112 of row 516. The formatting of the node “Child1.1” 606 corresponds to the interpretation by the server side application 112 of row 518. The other nodes 608, 610, 612, 614, 616 correspond to the interpretation by the server side application 112 of rows 520, 522, 524, 526, 528 respectively.

Therefore, FIG. 6 shows how the exemplary tree display region 600 can be constructed by interpreting the single line tree display data structure 500 via the server side application 112.

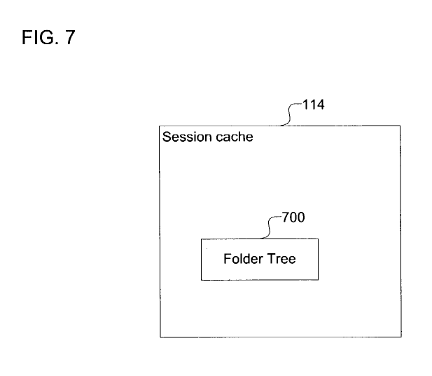

FIG. 7 illustrates the session cache 114 implemented in the server 100, in accordance with certain implementations of the invention. The session cache 114 is established when a new session starts between the browser 118 and the server side application 112. The session cache 114 stores a representation of the nodes in the tree data 108 that corresponds to the navigation tree 405 displayed on the browser 118. If nodes are opened and closed by selecting representative open/close icons 402, 404 then the content of the nodes in the tree data 108 corresponding to the navigation tree 405 do not change. In such a case, the session cache 114 can satisfy requests for opening and closing nodes in the navigation tree 405 displayed in the tree display region 202. The cached version of the navigation tree 405 is called a folder tree 700.

Therefore, the session cache 114 stores a folder tree 700 corresponding to the navigation tree 405 displayed in the tree display region 202 of the browser 118.

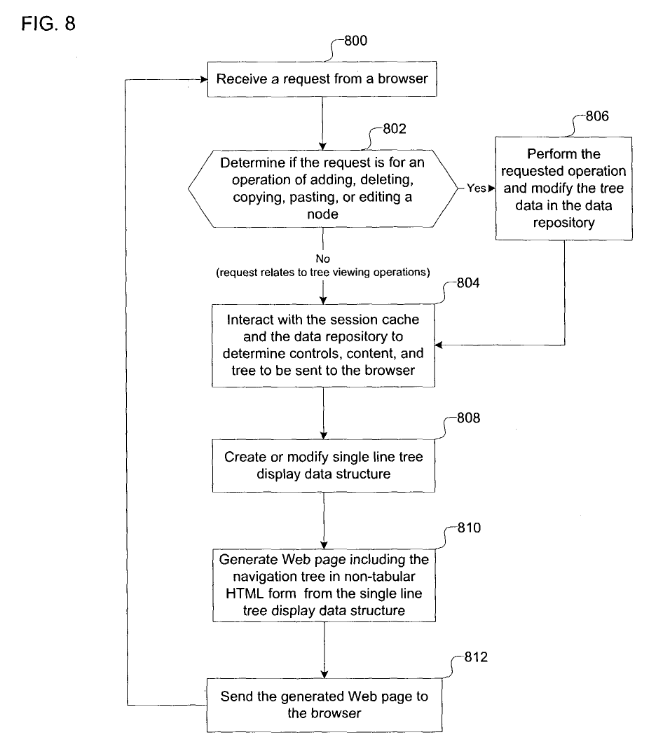

FIG. 8 illustrates logic for generating a Web page implemented in the server side application 112, in accordance with certain implementations of the invention. The server side application 112 sends the generated Web page to the browser 118 for display on the browser 118.

The process starts at block 800 where the server side application 112 receives a request from the browser 118. Control proceeds to block 802, where the server side application 802 determines if the request is for an operation of adding, deleting, copying, pasting or editing a node, i.e., the request from the browser 118 had arrived because of the selection of controls in the control region 204 of the browser 118. If not, the request may relate to the viewing and open/close operations of nodes on the navigation tree 405 and control proceeds to block 804. At block 804, the server side application 112 interacts with the session cache 114 and the data repository 106 to determine the code for the controls, content and the navigation tree to be sent to the browser 118.

If at block 802 the server side application 112 determines that the request is for an operation of adding, deleting, copying, pasting or editing a node then control proceeds to block 806. At block 806, the server side application 112 performs the requested operation and modifies the tree data 108 in the persistent data repository 106 and control proceeds to block 804 where the controls, content and navigation tree to be sent to the browser 118 are determined.

From block 804 control proceeds to block 808 where the server side application creates or modifies the single line tree display data structure 116 as required by the nodes of the navigation tree to be sent to the browser 118. The server side application 112 generates a Web page including the navigation tree in non-tabular textual HTML format by interpreting the single line tree display data structure 116. The generated Web page is sent (at block 812) to the browser 118. Control returns to block 800, where a new request is received from the browser 118 based on the Web page received by the browser 118.

Therefore, FIG. 8 shows how the server side application 112 generates a Web page including the navigation tree 405, controls for altering nodes of the navigation tree 405 and content for a node of the navigation tree 405.

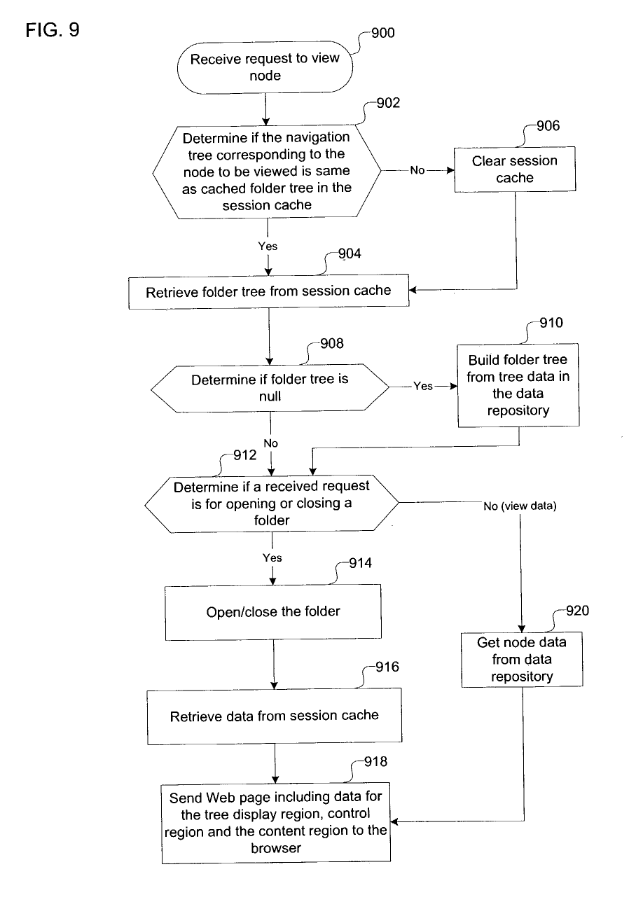

FIG. 9 illustrates logic for using the session cache 114 for generating a Web page implemented in the server side application 112, in accordance with certain implementations of the invention.

Control starts at block 900 where the server side application 112 receives a request from the browser 118 to view a node. Control proceeds to block 902 where the server side application 112 determines if the navigation tree 405 corresponding to the node to be viewed is the same as the cached folder tree 700 in the session cache 114. If so, the server side application 112 retrieves (at block 904) the cached folder tree 700 from the session cache 114.

If at block 902 it is determined that the navigation tree 405 corresponding to the node to be viewed is not the same as the cached folder tree 700 in the session cache 114 then the server side application 112 clears (at block 906) the session cache 114 and control proceeds to block 904.

From block 904, control proceeds to block 908 where the server side application 112 determines if the cached folder tree 700 is null. If so, then the server side application builds (at block 910) the cached folder tree 700 from the persistent tree data 108 in the data repository 106 and control proceeds to block 912. If at block 904, the server side application 112 determines that the cached folder tree 700 is not null then control proceeds to block 912.

At block 912, the server side application 112 determines whether a received request is for opening or closing a folder in the navigation tree 405. If so, control proceeds to block 914 where the server side application 112 generates code to open or close the corresponding folder in the navigation tree 405 and then retrieves (at block 914) data from the session cache 114. The server side application 112 sends a Web page including data for the tree display region 202 (i.e., the navigation tree 405), the control region 204, and the content region 206 to the browser 118.

If at block 912 the server side application 112 determines that the received request is not for opening or closing a folder the request may be for viewing data in the content region 206. In such a case, control proceeds to block 920, where the server side application 112 retrieves the corresponding node data from the tree data 108 and the Web page information 110 in the data repository 106.

Therefore, FIG. 9 describes how the server side application 112 retrieves data from the session cache 114 when folders are opened and closed in the navigation tree 405.

The implementations create a navigation tree in a Web page. The Web page includes controls for adding, deleting, and editing nodes of the navigation tree and also displays the content of a node of the navigation tree. The navigation tree, the controls, and the content are all displayed in a single window without frames. Therefore, the implementations create a dynamic navigation tree in a client-server environment without using frames.

The nodes in the navigation tree can be added, edited, copied and deleted. The nodes can also be opened and closed. The implementation is session based and the session cache improves the performance of system because open and close operations of the nodes may be satisfied from the session cache. The implementations also allow for a text based browser that does not support tables by formatting the nodes of the navigation tree as single line texts.

If a user bookmarks a page that includes a navigation tree then the absence of frames result in a true bookmark of the actual display of the page on the browser. Therefore there are no problems with bookmarking a page that includes a navigation tree.

The described techniques may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code for the implementations may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

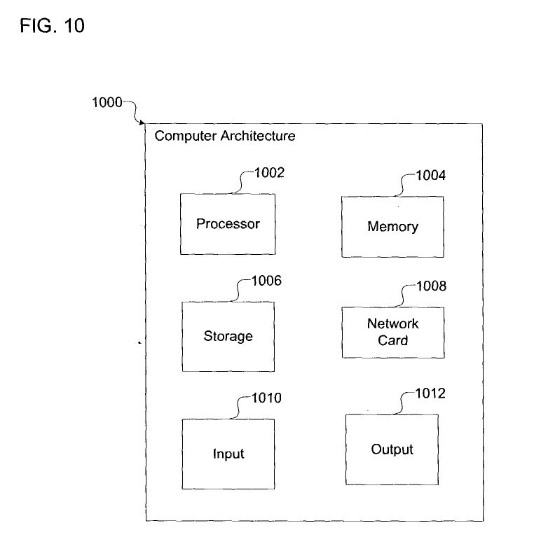

FIG. 10 illustrates a block diagram of a computer architecture in which certain aspects of the invention are implemented. FIG. 10 illustrates one implementation of the server 100 and the client 102. The server 100 and the client 102 may implement a computer architecture 1000 having a processor 1002, a memory 1004 (e.g., a volatile memory device), and storage 1006 (e.g., a non-volatile storage, magnetic disk drives, optical disk drives, tape drives, etc.). The storage 1006 may comprise an internal storage device, an attached storage device or a network accessible storage device. Programs in the storage 1006 may be loaded into the memory 1004 and executed by the processor 1002 in a manner known in the art. The architecture may further include a network card 1008 to enable communication with a network. The architecture may also include at least one input 1010, such as a keyboard, a touchscreen, a pen, voice-activated input, etc., and at least one output 1012, such as a display device, a speaker, a printer, etc.

The logic of FIGS. 8-9 describes specific operations occurring in a particular order. Further, the operations may be performed in parallel as well as sequentially. In alternative implementations, certain of the logic operations may be performed in a different order, modified or removed and still implement implementations of the present invention. Morever, steps may be added to the above described logic and still conform to the implementations. Yet further steps may be performed by a single process or distributed processes.

The client 102 and the server 100 communicate within a client-server paradigm in the described implementations. The client 102 and the server 100 may also communicate within a peer-to-peer or any other paradigm known in the art. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures, applications, agents, and components in FIGS. 1-10 are shown as having specific types of information. In alternative implementations, the data structures, agents, and components may be structured differently and have fewer, more or different fields, components or functions than shown in the figures.

Therefore, the foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

What is claimed is:

1. A method, comprising:
receiving a request for performing an operation;
performing the requested operation on a hierarchically arranged data;
generating code corresponding to a display of the hierarchically arranged data in a single window; and
sending the generated code.

2. The method of claim 1, wherein the generation further comprises:
creating a first code corresponding to a tree display of the hierarchically arranged data;
creating a second code corresponding to a content of a node of the hierarchically arranged data; and
creating a third code corresponding to at least one control for manipulating the hierarchically arranged data.

3. The method of claim 1, wherein the receiving, performing, generating and sending are performed by a server side application, the method further comprising:
if the requested operation is for opening or closing a node in the display of the hierarchically arranged data, then retrieving corresponding information from a cache coupled to the server side application, wherein the cache stores an arrangement of a plurality of nodes including the node in the display of the hierarchically arranged data.

4. The method of claim 1, wherein the display of the hierarchically arranged data is in the form of a tree, and wherein the generation further comprises:
creating a data structure including formatting instructing for at least one node of the tree; and
interpreting the data structure to create code corresponding to a linear display of the at least one node.

5. The method of claim 1, wherein the receiving, performing, generating and sending are performed by a server side application coupled to a data repository including the hierarchically arranged data, and wherein the server side application receives the request from a browser, and wherein the generated code is for a Web page for display on the browser, the method further comprising:
determining a session corresponding to the request;
determining a cache corresponding to the session; and
storing in the cache at least one arrangement corresponding to the display of the hierarchically arranged data.

6. The method of claim 1, wherein the single window has at most one frame, and wherein a bookmark corresponding to a universal resource locator of a page in the single window indicates a location of the generated code.

7. The method of claim 1, wherein the hierarchically arranged data is capable of being stored in a data repository in one arrangement, wherein the one arrangement is different from a hierarchical arrangement.

8. A method comprising:
displaying a first page in one window, wherein the first page includes a first hierarchical arrangement of nodes, at least one control related to the nodes, and a content of a node; and
selecting the at least one control to perform an operation remotely on at least one node.

9. The method of claim 8, further comprising:
receiving a response of a second page on the basis of the remotely performed operation, wherein the second page includes a second hierarchical arrangement of nodes; and
subsequent to receiving the response, bookmarking the second page, wherein the bookmarking saves an indicator to a location of the second page.

10. The method of claim 8, further comprising:
selecting one node in the first hierarchical arrangement of nodes;
receiving a second page, wherein the second page includes one content corresponding to the one selected node, the at least one control, and the first hierarchical arrangement of nodes; and
displaying the second page.

11. A system, comprising:
means for receiving a request for performing an operation;
means for performing the requested operation on a hierarchically arranged data;
means for generating code corresponding to a display of the hierarchically arranged data in a single window; and
means for sending the generated code.

12. The system of claim 11, wherein the means for generating code further performs:
creating a first code corresponding to a tree display of the hierarchically arranged data;
creating a second code corresponding to a content of a node of the hierarchically arranged data; and
creating a third code corresponding to at least one control for manipulating the hierarchically arranged data.

13. The system of claim 11, wherein the means for receiving, the means for performing, the means for generating, and the means for sending, comprise a server side application, the system further comprising:
a cache coupled to the server side application;
means for retrieving corresponding information from the cache, wherein the cache stores an arrangement of a plurality of nodes including the node in the display of the hierarchically arranged data, if the requested operation is for opening or closing a node in the display of the hierarchically arranged data.

14. The system of claim 11, wherein the display of the hierarchically arranged data is in the form of a tree, and wherein the means for generating further performs:
creating a data structure including formatting instructing for at least one node of the tree; and
interpreting the data structure to create code corresponding to a linear display of the at least one node.

15. The system of claim 11, wherein the means for receiving, the means for performing, the means for generating, and the means for sending, comprise a server side application, wherein the server side application receives the request from a browser, and wherein the generated code is for a Web page for display on the browser, the system further comprising:
a data repository including the hierarchically arranged data, wherein the data repository is coupled to the server side application;
means for determining a session corresponding to the request;
means for determining a cache corresponding to the session; and
means for storing in the cache at least one arrangement corresponding to the display of the hierarchically arranged data.

16. The system of claim 11, wherein the single window has at most one frame, and wherein a bookmark corresponding to a universal resource locator of a page in the single window indicates a location of the generated code.

17. The system of claim 11, wherein the hierarchically arranged data is capable of being stored in a data repository in one arrangement, wherein the one arrangement is different from a hierarchical arrangement.

18. A system comprising:
means for displaying a first page in one window, wherein the first page includes a first hierarchical arrangement of nodes, at least one control related to the nodes, and a content of a node; and
means for selecting the at least one control to perform an operation remotely on at least one node.

19. The system of claim 18, further comprising:
means for receiving a response of a second page on the basis of the remotely performed operation, wherein the second page includes a second hierarchical arrangement of nodes; and
means for bookmarking the second page subsequent to receiving the response, wherein the bookmarking saves an indicator to a location of the second page.

20. The system of claim 18, further comprising:
means for selecting one node in the first hierarchical arrangement of nodes;
means for receiving a second page, wherein the second page includes one content corresponding to the one selected node, the at least one control, and the first hierarchical arrangement of nodes; and
means for displaying the second page.

21. An article of manufacture, wherein the article of manufacture is capable of causing operations, the operations comprising:
receiving a request for performing an operation;
performing the requested operation on a hierarchically arranged data;
generating code corresponding to a display of the hierarchically arranged data in a single window; and
sending the generated code.

22. The article of manufacture of claim 21, wherein the generation further comprises:
creating a first code corresponding to a tree display of the hierarchically arranged data;
creating a second code corresponding to a content of a node of the hierarchically arranged data; and
creating a third code corresponding to at least one control for manipulating the hierarchically arranged data.

23. The article of manufacture of claim 21, wherein the receiving, performing, generating and sending are performed by a server side application, the operations further comprising:
if the requested operation is for opening or closing a node in the display of the hierarchically arranged data, then retrieving corresponding information from a cache coupled to the server side application, wherein the cache stores an arrangement of a plurality of nodes including the node in the display of the hierarchically arranged data.

24. The article of manufacture of claim 21, wherein the display of the hierarchically arranged data is in the form of a tree, and wherein the generation further comprises:
creating a data structure including formatting instructing for at least one node of the tree; and
interpreting the data structure to create code corresponding to a linear display of the at least one node.

25. The article of manufacture of claim 21, wherein the receiving, performing, generating and sending are performed by a server side application coupled to a data repository including the hierarchically arranged data, and wherein the server side application receives the request from a browser, and wherein the generated code is for a Web page for display on the browser, the operations further comprising:
determining a session corresponding to the request;
determining a cache corresponding to the session; and
storing in the cache at least one arrangement corresponding to the display of the hierarchically arranged data.

26. The article of manufacture of claim 21, wherein the single window has at most one frame, and wherein a bookmark corresponding to a universal resource locator of a page in the single window indicates a location of the generated code.

27. The article of manufacture of claim 21, wherein the hierarchically arranged data is capable of being stored in a data repository in one arrangement, wherein the one arrangement is different from a hierarchical arrangement.

28. An article of manufacture, wherein the article of manufacture is capable of causing operations, the operations comprising:
displaying a first page in one window, wherein the first page includes a first hierarchical arrangement of nodes, at least one control related to the nodes, and a content of a node; and
selecting the at least one control to perform an operation remotely on at least one node.

29. The article of manufacture of claim 28, further comprising:
receiving a response of a second page on the basis of the remotely performed operation, wherein the second page includes a second hierarchical arrangement of nodes; and
subsequent to receiving the response, bookmarking the second page, wherein the bookmarking saves an indicator to a location of the second page.

30. The article of manufacture of claim 28, further comprising:
selecting one node in the first hierarchical arrangement of nodes;
receiving a second page, wherein the second page includes one content corresponding to the one selected node, the at least one control, and the first hierarchical arrangement of nodes; and
displaying the second page.
